(19) United States
(12) Patent Application Publication
(10) Pub. No.: US 2012/0198741 A1
(43) Pub. Date: Aug. 9, 2012

(54) SUPPORT WITH INTERCHANGEABLE ALPHANUMERIC CHARACTERS

(75) Inventor: Timothy A. LAMM, Midlothian, VA (US)

(73) Assignee: Evergreen Enterprises, Inc., Richmond, VA (US)

(21) Appl. No.: 13/355,908

(22) Filed: Jan. 23, 2012

Related U.S. Application Data
(60) Provisional application No. 61/439,496, filed on Feb. 4, 2011.

(51) Int. Cl. G09F 15/00

(52) U.S. Cl. 40/607.11; 40/607.06

(57) ABSTRACT

A flagpole includes a stanchion, a footer disposed at a bottom of the stanchion to be embedded in a surface, an upper segment disposed adjacent to atop end of the stanchion, and a lower segment disposed adjacent to the upper segment at a distance further from the top end of the stanchion than the upper segment. A curved segment connects the top end of the stanchion to the lower segment. A plurality of alphanumeric characters are disposable on the upper segment. The upper segment includes a material attractive to a magnetized material, and the alphanumeric characters include the magnetized material therein an that the alphanumeric characters are removably attachable to the upper segment.

### CROSS-REFERENCE TO RELATED APPLICATION(S)

This United States Non-Provisional Patent Application relies for priority on U.S. Provisional Patent Application Ser. No. 61/439,496, filed on Feb. 4, 2011, the contents of which are incorporated herein by reference.

### FIELD OF THE INVENTION

The present invention concerns a flagpole or support that includes interchangeable alphanumeric characters that may be used to identify particular address, for example.

### DESCRIPTION OF THE RELATED ART

As should be apparent to those skilled in the art, there are numerous examples of devices that are employed to decorate a garden or otherwise improve upon the exterior appearance of an individual's home or business.

As may be apparent to those skilled in the art, decorative flags have become increasingly popular as an exterior, decorative embellishment for a home.

As may also be apparent to those skilled in the art, and also to any home owner, it is often desirable to place the house number in a location that is readily identifiable by a passerby to identify the address of the home.

U.S. Pat. No. 6,015,122 (hereinafter “the '122 Patent”) describes a flag holder with ornamental lettering 42 being affixed thereto. (The '122 Patent at col. 2, lines 51-53.) The '122 Patent, however, does not provide for removable alphanumeric characters, among other features.

### SUMMARY OF THE INVENTION

The present invention seeks to provide a flagpole or stanchion that may securely carry alphanumeric characters to identify a person's address.

The present invention also seeks to provide a convenient location for display of a garden flag or other decorative item.

While the present invention contemplates use with a flag made from a fabric, the present application is intended to provide a platform for a wide variety of decorative items.

The present invention provides for a support that includes a stanchion with a first end and a second end, an upper segment, having a first end and a second end, wherein the first end of the upper segment is connected adjacent to the second end of the stanchion such that the upper segment extends outwardly from the stanchion, and a lower segment, having a first end and a second end, wherein the first end of the lower segment is connected to the stanchion adjacent to the first end of the upper segment and wherein the upper segment and the lower segment are separated from one another by a predetermined distance. The support also includes a first magnetically-attractive material incorporated into the upper segment between the first and second ends of the upper segment, a plurality of alphanumeric characters disposable on the upper segment, and a second magnetically-attractive material incorporated into each of the plurality of alphanumeric characters, the first and second magnetically-attractive materials being complimentary of one another such that that the plurality of alphanumeric characters are removably attachable to the upper segment.

one contemplated embodiment, the support includes a footer disposed at the first end of the stanchion. The footer may include an L-shaped member attached to the stanchion adjacent to the first end of the stanchion, thereby permitting the footer to be inserted into a surface.

In another contemplated embodiment, the support includes a curved segment connected to the second end of the stanchion and extending from the second end of the stanchion to the first end of the lower element. in this contemplated embodiment, the upper segment and the lower segment are offset with respect to one another such that the upper segment and the lower segment are not coplanar with one another.

It is also contemplated that the support may be constructed so that a curved segment connects to the second end of the stanchion and extends from the second end of the stanchion to a location where the first end of the lower element connects to the stanchion. In this embodiment, the upper segment and the lower segment are both connected to the stanchion and are coplanar with one another.

The present invention also is intended to encompass a support where the first magnetically attractive material is an iron-containing material and the second magnetically attractive material comprises a plurality of magnets.

In an alternative embodiment, the first magnetically attractive material comprises a plurality of magnets that the second magnetically attractive material comprises an iron-containing material.

In a further embodiment, the lower segment includes a curved end that extends from the second end of the lower segment to a position adjacent to the upper end of the upper segment. The curved end and the second end of the upper segment may be separated from one another by a gap.

It is contemplated that the stanchion will be made from metal, such as an aluminum-containing material or an iron-containing material. If so, it is contemplated that the stanchion may be coated by at least one of paint or a powder coating to reduce oxidation thereof.

The alphanumeric characters may be made from plastic, rubber, resin, or acrylonitrile butadiene styrene.

Other aspects of the present invention will be made apparent from the description that follows.

### BRIEF DESCRIPTION OF THE DRAWINGS

The present invention will now be described in connection with the drawings appended hereto, in which:

FIG. 1 is a side view of one embodiment of the present invention, the view being provided as a schematic view;

FIG. 2 is a side view of the embodiment of the present invention illustrated in FIG. 1, showing the addition of a flag with graphical indicia;

FIG. 3 is an enlarged, exploded view of the bottom surface of one of the alphanumeric characters that for a part of the present invention; and

FIG. 4 is a cross-sectional end view of the embodiment illustrated in FIG. 1, the cross-section being taken along line 4-4 in FIG. 1.

### DETAILED DESCRIPTION OF EMBODIMENT(S) OF THE INVENTION

The present invention will now be described in connection with one or more embodiments. While specific examples are discussed, the present invention is not intended to he limited to those examples. To the contrary, after understanding the present disclosure, those skilled in the art will appreciate that there are numerous equivalents and variations of the embodiments discussed herein that may be employed. The present invention is intended to encompass those equivalents and variations.

While the present invention will be described in connection with a flagpole 10, which is one contemplated embodiment, the present invention should not be understood to be limited solely to supports for flags. To the contrary, it is contemplated that the support 10 of the present invention may be used to support any number of items, both decorative and non-decorative. In the discussion that follows, the terms “flagpole” and “support” are used interchangeably. The term “support” is intended as a term encompassing any support onto which an item is disposed, whether the item is decorative or not.

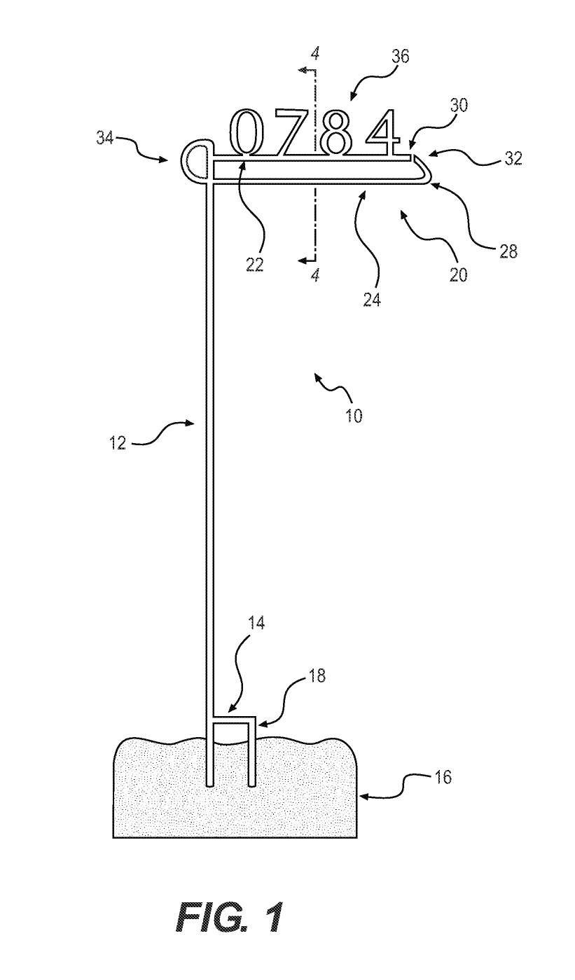

FIG. 1 is a side view, schematic illustration of an embodiment of the support or flagpole 10 according to one embodiment of the present invention. The flagpole 10 includes a vertical stanchion 12 that extends upwardly from a footer 14 that is secured in the ground 16.

The footer 14 includes an L-shaped member 18 that extends to one side of the stanchion 12. Together with the bottom end of the stanchion 12, the L-shaped member 18 forms a U-shaped fork that defines the footer 14, which is inserted into the ground 16. The L-shaped member 18 provides additional stability for the flagpole 10 when inserted into the ground 16.

While the footer 14 is contemplated as one embodiment of the support 10 of the present invention, other means for attaching the support 10 to a substrate may be employed without departing from the scope of the present invention. For example, the stanchion 12 may be attached to a. plate that is secured, via fasteners, to a suitable surface.

Additionally, while the support 10 of the present invention is described in connection with its attachment to a horizontal surface (such as the ground), the present invention is not limited solely to such a construction. It is contemplated that the support or flagpole 10 of the present invention may be secured to vertical or angled surfaces without departing from the scope of the present invention. If attached to an angled or a vertical surface, it is contemplated that the support will engage a plate that is fastened to the surface via suitable fasteners or an adhesive.

The top of the stanchion 12 includes an arm 20 that extends laterally therefrom. The arm includes an upper segment 22 and a lower segment 24. In the illustrated embodiment, the upper segment 22 is essentially a straight bar that extends from the stanchion 12. The lower segment 24 also includes a linear portion 26 with a curved end 28 that extends to a position adjacent to a free end 30 of the upper segment 22. The curved end 28 and the free end 30 are separated by a gap 32.

The top end of the stanchion 12 also includes a curved segment 34 that extends from the top end of the stanchion to the lower segment 24. The curved segment 34 connects the stanchion to the lower segment 24, which is not in the same plane as the upper segment 22, at least for the embodiment illustrated in FIG. 1.

In an alternative embodiment, it is contemplated that the upper and lower segments 22, 24 may be in the same plane and/or that the curved segment 34 may be removed altogether. Further discussion of the upper and lower segments 22, 24 is provided in the paragraphs that follow.

The upper segment 22 is configured to receive the alphanumeric characters 36 thereon. In the illustrated embodiment, the alphanumeric characters 36 are removably secured to the upper segment 22. Being removably secured, it becomes possible for the owner to alter the message conveyed by the alphanumeric characters 36. In one contemplated embodiment, the alphanumeric characters 36 may identify a street address, as illustrated in FIG. 1. In another contemplated embodiment, the alphanumeric characters 36 may convey a message such as “Happy Holidays,” etc.

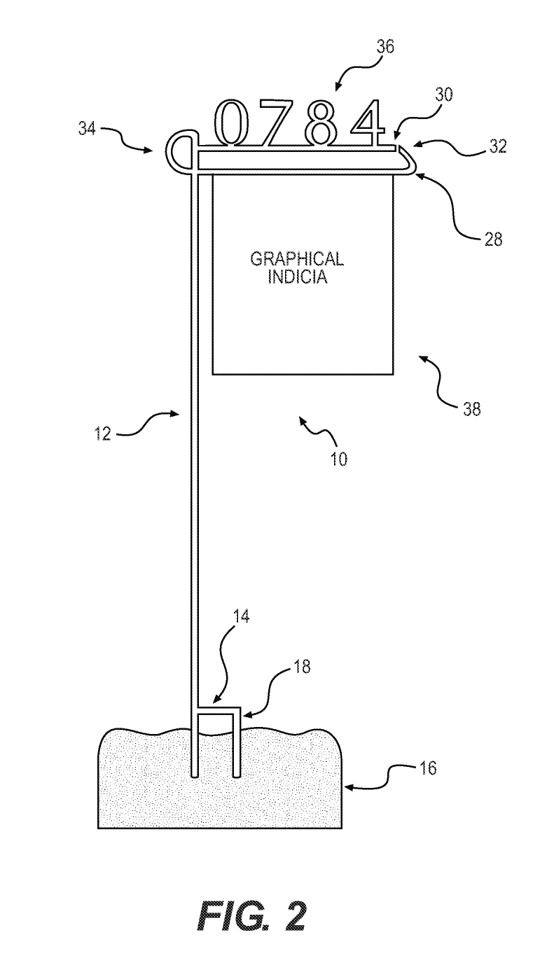

Reference is now made to FIG. 2. As illustrated, a flag 38 (or other item containing graphical or non-graphical indicia) may be provided on the lower segment 24 of the arm 20. The flag 38 includes a linear loop (or hemmed section) at the top thereof so that the top of the flag 38 may slide onto the lower segment 24. To position the flag 38 on the lower segment 24, the loop slidingly engages the lower segment 24, which is accessible via the gap 32 between the upper segment 22 and the lower segment 24.

As indicated above, for the illustrated embodiment, the lower segment 24 is an extension of the curved segment 34 that extends from the top of the stanchion 12. The curved segment 34 provides a greater degree of flexibility to the lower segment 24 so that a person can access the lower segment 24 to position a flag 28 thereon. In other words, the curved segment 34 permits a user to bend the lower segment 24 to a greater degree with respect to the stanchion 12 than if the lower segment is connected directly to the stanchion 12. Naturally, the degree of flexibility will depend on the material selected for the various elements of the flagpole 10. The curved end 28 prevents the flag 38 from falling off of the flagpole 10, for example, under windy conditions.

It is contemplated that the flagpole 10 will be made from an aluminum-based alloy or an iron-based alloy, such as steel. Other materials that may be employed without departing from the scope of the present invention include, but are not limited to, polyvinylchloride, polyethylene, and composite materials (i.e., carbon fiber composite materials). If made from metal, the flagpole 10 may be covered in paint or a powdered material to inhibit oxidation of the metal. Other coatings may be employed as should be apparent to those skilled in the art.

Regardless of the materials used for the flagpole 10, it is contemplated that the upper member 22 will include an iron-based material (or suitable alternative) to which magnets may be attached.

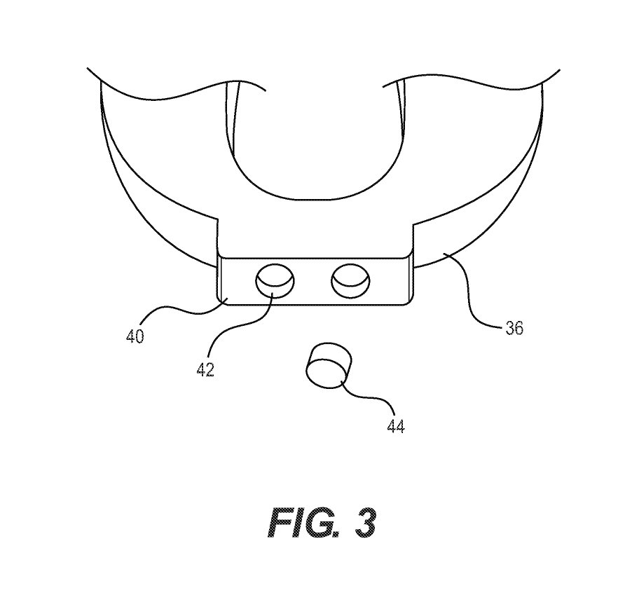

With reference to FIG. 3, the alphanumeric characters 36 each include a bottom 40 with one or more holes 42 therein. Magnets 44 are inserted into the holes 42. Since the upper segment 22 is made from iron or includes a magnetically attractive material, the magnets 44 are removably attachable to the upper segment 22. In the illustrated embodiment, the magnets have a diameter of 4 mm and a thickness of 4 mm. Naturally, magnets 44 of any suitable size or dimension may be employed without departing from the scope of the present invention.

It is contemplated that the alphanumeric characters 36 will be made from a material such as plastic, rubber, resin, acrylonitrile butadiene styrene (“ABS”), or a similar material. Being removable, alphanumeric characters 36 are reconfigurable to present any message desired by the owner, as indicated above.

With respect to the upper segment 22, it is contemplated that the top side will include a track at the location where the alphanumeric characters 36 magnetically connect thereto. The track is anticipated to permit water to drain easily from the flagpole 10.

Concerning the stanchion 12, in one contemplated variation of the present invention, the stanchion 12 is made from a powder coated metal. The powder coating is expected to minimize oxidation (or rusting) of the metal. Alternatively, various components of the support 10 may be painted to minimize oxidation.

While the flagpole 10 may be made to meet any suitable dimensions, it is anticipated that the height of the stanchion 12 is about 43 inches (109.22 cm). The width of the flagpole 10 is anticipated to be about 16 inches (40.64 cm). The alphanumeric characters 36 are anticipated to have a height of about 4 inches (10.16 cm) and a width of about 2 inches (5.08 cm).

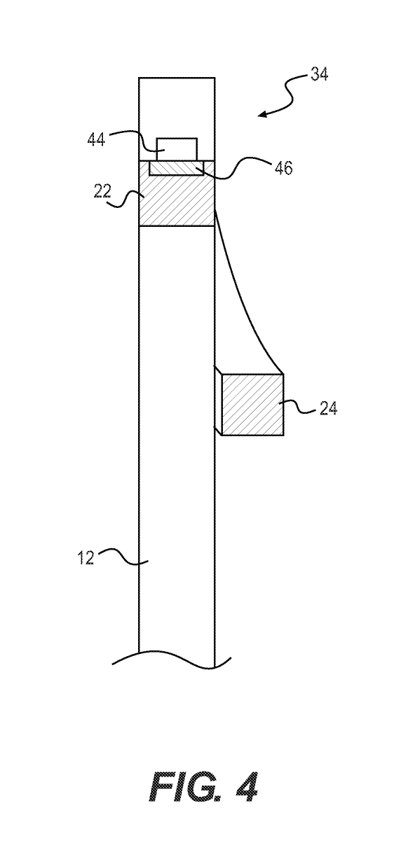

FIG. 4 is a cross-sectional end view of the flagpole 10 of the present invention, illustrating the offset between the upper segment 22 and the lower segment 24. The curved segment 34, which connects to the top end of the stanchion, transitions into the off-set position so that the lower segment 24 is not co-planar with the upper segment 22. As noted above, with this construction, the lower segment 24 is afforded a greater degree of flexibility. As such, a person threading a flag 38 onto the lower segment 24 may widen the gap 32 to a greater extent, thereby facilitating installation of the decorative item on the support 10.

As noted above, the lower segment 24 may be co-planar with the upper segment 22 in a further contemplated embodiment of the present invention. If so, the lower segment 24 will be connected to the stanchion 12 at a position adjacent to the upper segment 22. In other words, in this alternative embodiment, the upper and lower segments 22, 24 are both connected to the stanchion 12 and are separated from one another by a predetermined distance. The upper and lower segments 22, 24 may be connected to the stanchion via welding, fasteners, and/or adhesives, etc.

Concerning the connection of the alphanumeric characters 36 to the upper segment 22, one embodiment is discussed above. In this first embodiment, the alphanumeric characters 36 include magnets 44 and the upper segment 22 includes suitable material to which the magnets 44 are attracted.

As noted above, the upper segment 22 is provided an iron-based material or a track containing an iron-based material. FIG. 4 illustrates the iron-based material as an insert 46 to which the magnets 44 are attracted. While the iron-based material is illustrated as an insert 46, the upper segment 22 may be manufactured from an iron-containing material or other material to which the magnets 44 are attracted. If so, a track 46 need not be provided.

It is noted that this orientation of elements may be reversed without departing from the scope of the present invention. For example, the magnets 44 may be replaced by iron-containing materials and the track 46 may be magnetically biased.

For purposes of the present invention, therefore, the upper segment 22 is provided with a first magnetically attractive material and the alphanumeric characters 36 are provided with a second magnetically attractive material. The first and second magnetically attractive materials are complimentary of one another, thereby facilitating an attractive force therebetween. The exact positioning of the materials is not critical to the operation of the present invention.

Other variations and equivalents may be appreciated by those skilled in the art. Those variations and equivalents are intended to be encompassed by the present invention.

What is claimed is:

1. A support, comprising:
a stanchion with a first end and a second end;
an upper segment, having a first end and a second end, wherein the first end of the upper segment is connected adjacent to the second end of the stanchion such that the upper segment extends outwardly from the stanchion;
a lower segment, having a first end and a second end, wherein the first end of the lower segment is connected to the stanchion adjacent to the first end of the upper segment and wherein the upper segment and the lower segment are separated from one another by a predetermined distance;
a first magnetically-attractive material incorporated into the upper segment between the first and second ends of the upper segment;
a plurality of alphanumeric characters disposable on the upper segment; and
a second magnetically-attractive material incorporated into each of the plurality of alphanumeric characters, the first and second magnetically-attractive materials being complimentary of one another such that that the plurality of alphanumeric characters are removably attachable to the upper segment.

2. The support of claim 1, further comprising:
a footer disposed at the first end of the stanchion.

3. The support of claim 2, wherein the footer comprises:
an L-shaped member attached to the stanchion adjacent to the first end of the stanchion, thereby permitting the footer to be inserted into a surface.

4. The support of claim 1, further comprising:
a curved segment connected to the second end of the stanchion and extending from the second end of the stanchion to the first end of the lower element.

5. The support of claim 4, wherein the upper segment and the lower segment are offset with respect to one another such that the upper segment and the lower segment are not coplanar with one another.

6. The support of claim 1, further comprising:
a curved segment connected to the second end of the stanchion and extending from the second end of the stanchion to a location where the first end of the lower element connects to the stanchion.

7. The support of claim 6, wherein the upper segment and the lower segment are both connected to the stanchion and are coplanar with one another.

8. The support of claim 1, wherein the first magnetically attractive material is an iron-containing material and the second magnetically attractive material comprises a plurality of magnets.

9. The support of claim 1, wherein the first magnetically attractive material comprises a plurality of magnets that the second magnetically attractive material comprises an iron-containing material.

10. The support of claim 1, wherein the lower segment further comprises:
a curved end that extends from the second end of the lower segment to a position adjacent to the upper end of the upper segment.

11. The support of claim 10, wherein the curved end and the second end of the upper segment are separated from one another by a gap.

12. The support of claim 1, wherein at least the stanchion comprises metal.

13. The support of claim 12, wherein the metal is at least one of an aluminum-containing material or an iron-containing material.

14. The support of claim 12, wherein at least the stanchion is coated by at least one of paint or a powder coating to reduce oxidation thereof.

15. The support of claim 1, wherein the alphanumeric characters comprise at least one of plastic, rubber, resin, or acrylonitrile butadiene styrene.
